(19) United States
(12) Patent Application Publication
(10) Pub. No.: US 2006/0266275 A1
(43) Pub. Date: Nov. 30, 2006

(54) LEAD-IN BUMPER FOR A LOADING DOCK

(76) Inventors: Joseph J. DiBiase, Vaughan, ON (CA); Paul J. Maly, Mequon, WI (US); Walter J. Swietlik, Cedarburg, WI (US)

Correspondence Address: HANLEY, FLIGHT & ZIMMERMAN, LLC, 20 N. WACKER DRIVE, SUITE 4220, CHICAGO, IL, 60606, US

(21) Appl. No.: 11/461,940

(22) Filed: Aug. 2, 2006

Related U.S. Application Data
(63) Continuation of application No. 10/068,580, filed on Feb. 6, 2002, now abandoned.

(51) Int. Cl. G01C 15/02

(52) U.S. Cl. 116/201

(57) ABSTRACT

A bumper system for a loading dock includes an engagement member and a guide member mounted to the face of the dock. The guide member helps guide a vehicle toward the engagement member, which receives the primary impact of the vehicle backing into the dock. If the vehicle is excessively off to one side, the guide member of some embodiments may affect the operation of a dock leveler, vehicle restraint, dock seals, or a door associated with the loading dock. In some embodiments when the vehicle is off to one side the guide member may inhibit the vehicle from reaching the engagement member.

### CROSS REFERENCE TO RELATED APPLICATIONS

This application is a continuation of U.S. patent application Ser. No. 10/068,580 entitled “Lead-in Bumper for a Loading Dock,” filed Feb. 6, 2002, and incorporated herein by reference in its entirety.

### FIELD OF THE DISCLOSURE

The subject invention generally pertains to dock bumpers and more specifically to one that helps ensure that a vehicle is properly positioned at the dock.

### BACKGROUND OF RELATED ART

A typical loading dock of a building includes an exterior doorway with an elevated platform for loading and unloading vehicles, such as trucks and trailers. Currently, there are numerous products available for improving a loading dock's operating conditions, function, safety, and/or usefulness. For example, dock shelters or compressible dock seals installed along the perimeter of the doorway are adapted to seal against the rear portion of the truck to help seal out weather, as the truck is being loaded or unloaded of its cargo.

To compensate for height differences between the loading dock platform and an adjacent bed of a truck or trailer, many loading docks include a dock leveler. A typical dock leveler includes a deck, also known as a ramp or dockboard, which is pivotally hinged along its back edge to vary the height of its front edge. An extension plate, or lip, extends outward from the deck's front edge to span the gap between the rear of the truck bed and the front edge of the deck. Depending on the particular dock leveler, some lips move linearly and others pivot between a stored position and an extended, operative position. In moving to the stored position, the lip usually retracts to where it does not interfere with a vehicle backing into the dock. In the extended, operative position, the lip extends from the deck's front edge and rests upon the truck bed to form a bridge between the two. This allows personnel and material handling equipment to readily move on and off the vehicle during loading and unloading operations.

When loading or unloading a truck at a loading dock, it is generally a safe practice to help restrain the truck from accidentally moving too far away from the dock. This is often accomplished by a hook-style vehicle restraint that engages what is referred to in the industry as an ICC bar or a Rear Impact Guard (RIG). An ICC bar or RIG is a bar or beam that extends horizontally across the rear of a truck, below the truck bed. Its primary purpose is to help prevent an automobile from under-riding the truck in a rear-end collision. However, an ICC bar also provides a convenient structure for a hook-style restraint to reach up in front of the bar to obstruct the truck's movement away from the dock. To release the truck, many restraints lower to a stored position below the bar, which then allows the next truck to back into the dock. Other hook-style restraints store in a normally raised position and include an inclined lead-in that an ICC bar uses to help push the restraint underneath the bar as the truck backs into the dock. Once underneath the bar, usually a barrier rises in front of the bar to restrain the truck.

To protect the building and the dock leveler from direct vehicle impact and to protect dock seals from being completely crushed by a truck backing into the dock, loading docks often include bumpers. Bumpers also help establish a certain amount of clearance between the rear of the truck and the dock leveler, so the dock leveler can first raise and then lower its lip upon the rear edge of the truck with a safe amount of overlap, or lip purchase, between the lip and the truck bed. Establishing a predetermined distance between the rear of the truck and the dock face also helps ensure that a vehicle restraint is able reach out and engage the front edge of the truck's ICC bar. Bumpers are usually installed near the bottom of the doorway, adjacent either side of the dock leveler lip and protrude a few inches out from the face of the dock where they can be abutted by the rear of the vehicle.

Unfortunately, conventional dock bumpers do not always ensure that the rear of the vehicle is properly positioned relative to the loading dock's doorway, dock leveler, vehicle restraint, dock seal, or dock shelter. For instance, the rear of the truck may stop excessively short of reaching the bumper, or the truck may be offset to either side of the doorway. If the truck stops far short of the bumper, several problems may occur. The vehicle restraint may be unable to reach out far enough to hook the front of the ICC bar, the dock seal or dock shelter may fail to fully engage the rear of the truck, there may be insufficient lip purchase between the rear of the truck bed and an extended dock leveler lip, or the dock leveler lip may miss the rear edge of the truck bed entirely. If the truck is off centered relative to the doorway, the dock seal or dock shelter may leave one side of the truck relatively unsheltered, the truck might crush one side of a dock shelter, or the dock leveler lip may be unable fit inside the truck.

Consequently, in addition to bumpers, sometimes bollards or wheel guides are anchored to the driveway of a loading dock to create an obstruction that establishes lateral limits within which a truck may travel. Low profile wheel guides may be difficult to see if they get covered with snow, and almost any protrusion extending upward from the driveway may interfere with snow removal.

### SUMMARY

In some embodiments, a bumper includes a guide member adjacent an engagement member, wherein the guide member helps guide a vehicle toward the engagement member.

In some embodiments, the guide member protrudes further away from a loading dock face than does the engagement member.

In some embodiments, the engagement member is higher than the guide member to ensure that the bumper can engage vehicles with relatively high truck beds and avoid damaging hinged door panels on the vehicle.

In some embodiments, the bumper includes a tapered surface that helps urge the vehicle in position.

In some embodiments, the bumper includes a vehicle sensor.

In some embodiments, the vehicle sensor is the guide member itself.

In some embodiments, the vehicle sensor controls the operation of an indicator light.

In some embodiments, the vehicle sensor controls the operation of a vehicle restraint, inflatable dock seals, a dock leveler, and/or a dock door.

In some embodiments, the guide member and engagement member are integrally joined to each other.

In some embodiments, the guide member and engagement member are adjacent, but spaced apart from each other.

In some embodiments, the guide member and engagement member are mounted to a dock face to avoid creating an obstruction on the driveway approach of the loading dock.

### BRIEF DESCRIPTION OF THE DRAWINGS

FIG. 1 is a perspective view of a vehicle backing into a loading dock that includes a bumper system according to one embodiment.

FIG. 2 is similar to FIG. 1, but with the vehicle properly backed up against a dock seal with a lip of a dock leveler resting atop the truck bed.

FIG. 3 is a top view of FIG. 1.

FIG. 4 is a top view of FIG. 2.

FIG. 5 is a top view similar to FIG. 4, but the vehicle improperly offset to one side.

FIG. 6 is a perspective view of a bumper according to another embodiment.

FIG. 7 is a top view similar to FIGS. 3 and 4, but with the bumper of FIG. 6 guiding the vehicle into position.

FIG. 8 is a perspective view of a bumper according to another embodiment.

FIG. 9 is a top view similar to FIG. 7, but with the bumper of FIG. 8.

FIG. 10 is a perspective view of a bumper according to another embodiment.

FIG. 11 is a top view similar to FIG. 7, but with the bumper of FIG. 10.

FIG. 12 is a top view of a vehicle properly backing into a loading dock that includes of a bumper according to another embodiment.

FIG. 13 is a top view similar to FIG. 12, but with the vehicle offset to one side.

### DETAILED DESCRIPTION

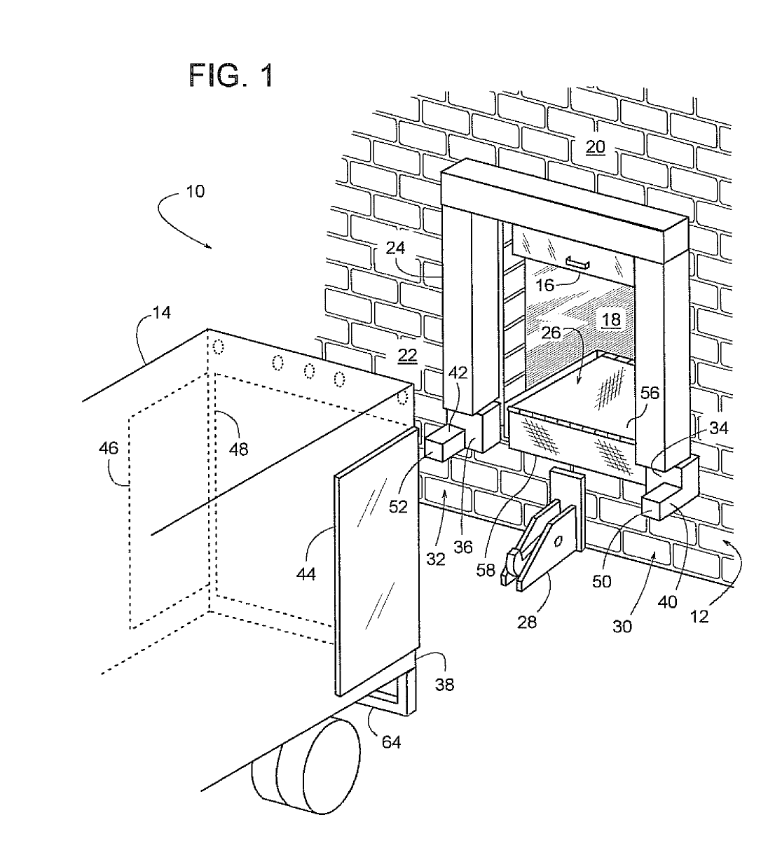

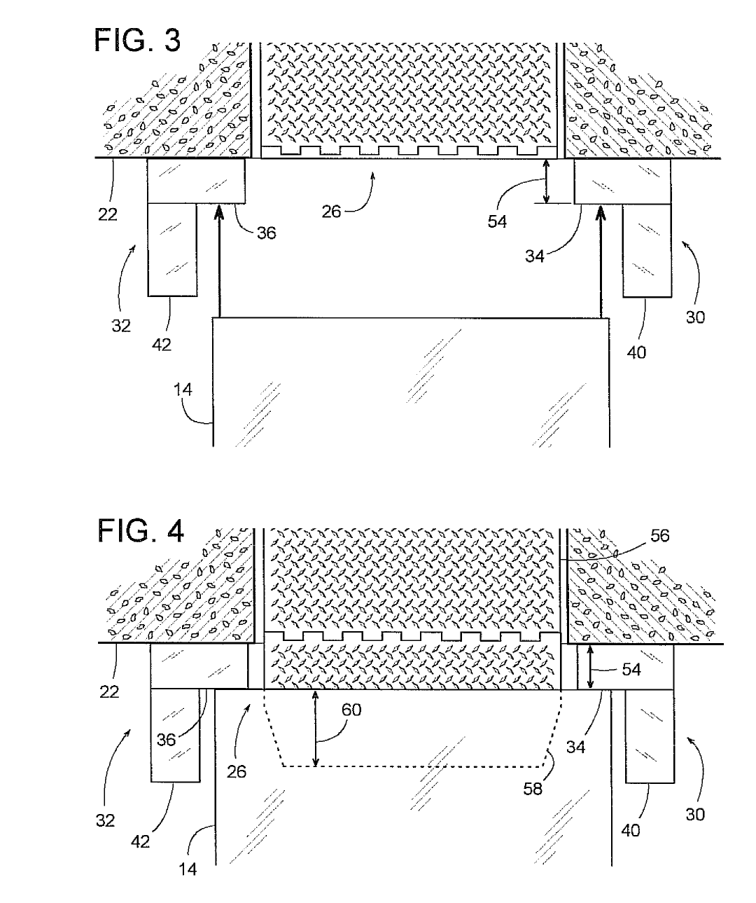

A loading dock 10, of FIG. 1, includes a bumper system 12 that not only absorbs vehicle impacts, but also helps guide a vehicle 14 to a proper loading/unloading position. Depending on the particular loading dock, bumper system 12 may help guide vehicle 14 relative to a door 16 or doorway 18 of a building 20, a dock face 22, dock seal 24 (or a dock shelter), a dock leveler 26, and a vehicle restraint 28. To do this, bumper system 12 includes a right hand bumper 30 and a left hand bumper 32 that each include an engagement member 34 and 36, respectively, for establishing a predetermined proper distance between dock face 22 and a rear edge 38 of vehicle 14. Bumpers 30 and 32 also include guide members 40 and 42, respectively, that help centrally align vehicle 14 to doorway 18. Bumpers 30 and 32 generally have an L-shape (e.g., as viewed from the top in FIG. 3 with engagement member 36 being a first leg of the L-shape, and guide member 42 being a second leg of the L-shape); however, other shapes are also well within the scope of the invention.

In operation, vehicle 14 first backs into dock 10, as shown in FIGS. 1 and 3. If vehicle 14 includes swinging door panels 44 and 46 that cover a rear access opening 48 in vehicle 14, the door panels are swung open before the rear of vehicle 14 engages dock seal 24. Otherwise, dock seal pressing against the rear edges of vehicle 14 would interfere with opening the doors. Door panels 44 and 46 being open while the rear of vehicle 14 is up against seal 24 allows access into vehicle 14 from within building 20 for loading and unloading cargo.

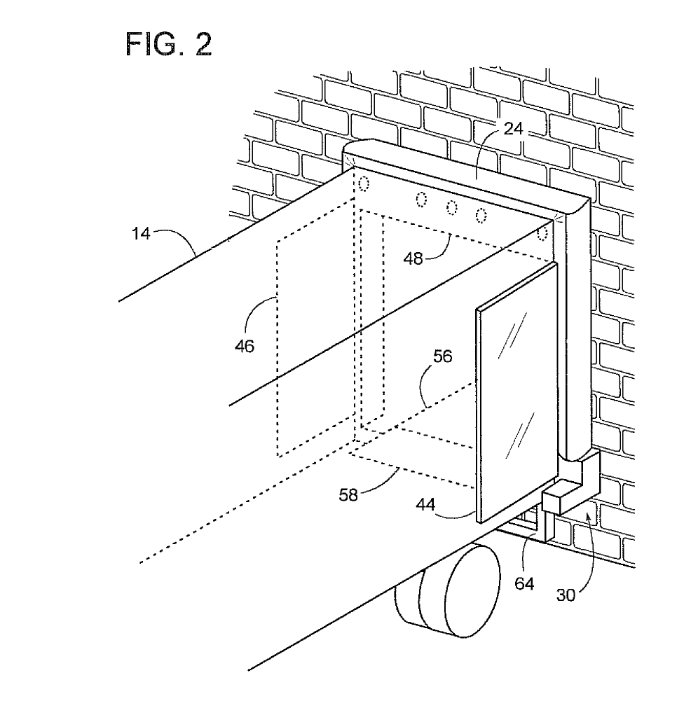

As vehicle 14 travels from its position of FIGS. 1 and 3 to that of FIGS. 2 and 4, surfaces 50 and 52 provide the driver of vehicle 14 with a visual reference that assists in keeping vehicle 14 generally centered within guide members 40 and 42. With surfaces 50 and 52 remaining visible, the driver knows vehicle 14 is properly positioned at the dock when he senses the rear of vehicle 14 bumping up against engagement member 34 and/or 36.

Engagement members 34 and 36 define a certain distance 54 or clearance between dock face 22 and the rear edge of vehicle 14, as shown in FIGS. 3 and 4. The clearance allows dock leveler 26 to operate its pivotal ramp 56 and lip 58 to set lip 58 atop the floor of vehicle 14 with an appropriate amount of lip purchase 60, as shown in FIG. 4. The actual operation of dock leveler 26 depends on its particular design, as dock leveler 26 is schematically illustrated to represent all types of dock levelers known to those skilled in the art.

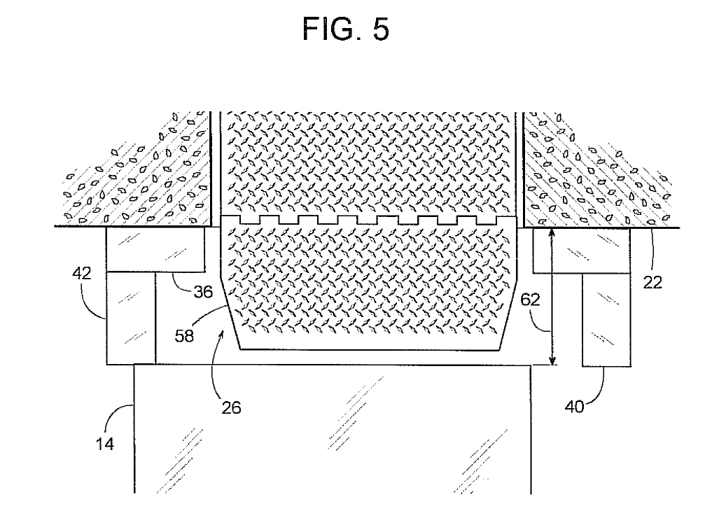

If vehicle 14 is excessively off to one side as it backs into loading dock 10, the rear edge of vehicle 14 may abut either guide member 40 or 42. In FIG. 5, for example, guide member 42 keeps vehicle 14 at such an appreciable distance 62 away from dock face 22 that dock leveler lip 58 is unable to reach the rear edge of vehicle 14. Guide member 42 extending farther out from dock face 22 than what lip 58 can extend avoids creating a hazardous situation of marginal lip purchase. With the rear edge of vehicle 14 being at either of one of two locations: up against engagement member 36 (FIG. 4), or up against guide member 42 (FIG. 5), the amount of lip purchase will either be acceptable or nonexistent.

This “Go/No-Go” mode of operation not only applies to proper positioning of vehicle 14 with respect to its distance away from dock face 22, but also applies to the vehicle's central alignment (lateral alignment in a horizontal direction parallel to dock face 22). For instance, vehicle 14 being between guide members 40 and 42 ensures that lip 58 can fit between the side edges of the vehicle's rear access opening 48. If it were not for guide members 40 and 42, vehicle 14 may be so offset to one side that lip 58 may be unable to extend through access opening 48 or may scrape along an inside edge of the opening.

The bumper system's alignment feature as it applies to dock levelers also applies to dock seal 24 and vehicle restraint 28 in a similar manner. Vehicle 14 being up against engagement members 34 and 36 helps ensure that vehicle restraint 28 is able reach ICC bar 64 of vehicle 14, and helps ensure that the rear surface of vehicle 14 is engaging seals 24 without crushing them. And vehicle 14 being between guide members 40 and 42 ensures that the rear vertical edges of vehicle 14 are properly aligned with the two vertical side pads of dock seal 24.

To avoid damaging a truck door or its hinges, guide members 40 and 42 are preferably at an elevation that is below the lowest anticipated height of a truck door's lower edge. This prevents a truck from forcing the hinged edge of its open door against a guide member. However, to ensure that bumpers 30 and 32 are still able to engage relatively high truck beds, portions of engagement members 34 and 36 are higher than guide members 40 and 42.

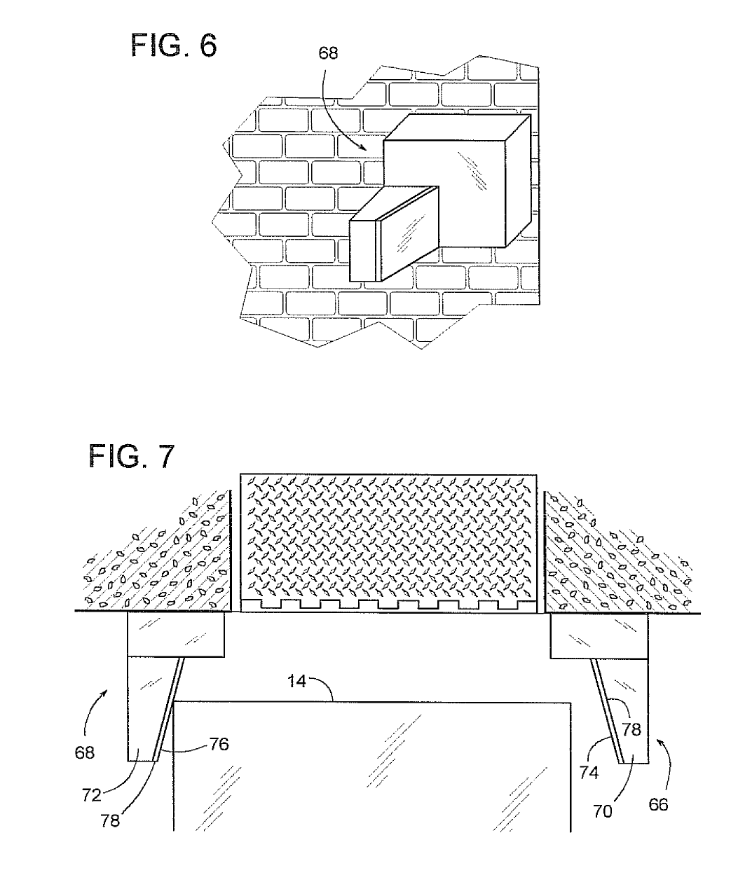

In a similar embodiment, shown in FIGS. 6 and 7, bumpers 66 and 68 are provided with guide members 70 and 72 that include tapered surfaces 74 and 76. The tapered surfaces provide a gradual lead-in that helps guide and may even urge the rear of vehicle 14 toward its proper position between guide members 70 and 72. Surfaces 74 and 76 may be provided by an anti-friction member 78, which is schematically illustrated to represent members such as an UHMW polyethylene sheet, steel plate, conveyor belt, series of rollers, etc.

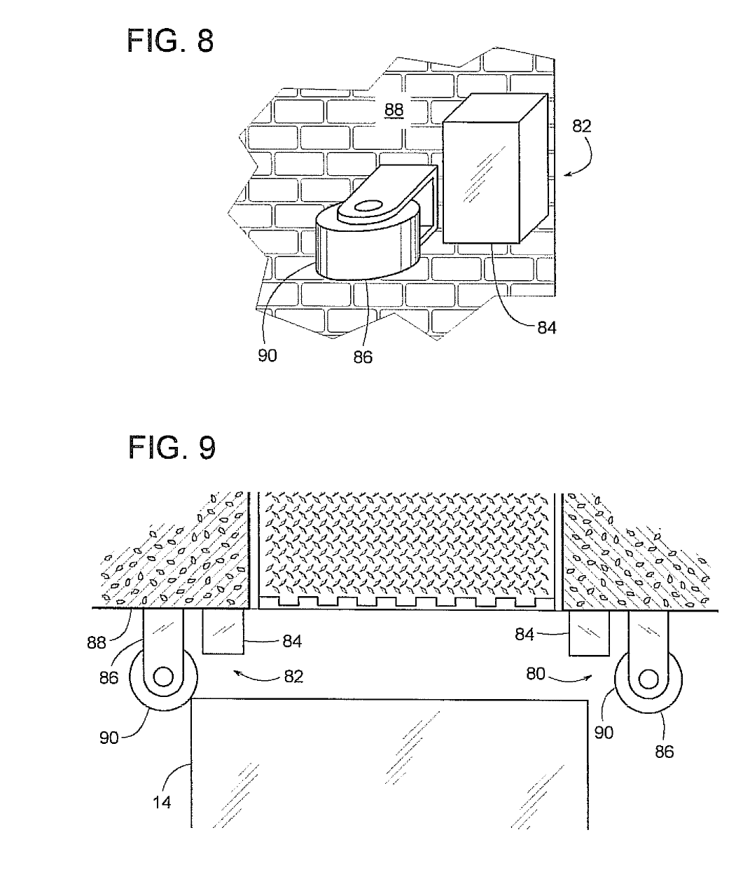

In another embodiment, shown in FIGS. 8 and 9, bumpers 80 and 82 each include an engagement member 84 and a guide member 86 that are mounted separately to a dock face 88. Mounting engagement member 84 and guide member 86 separately allows more freedom in the vertical and horizontal displacement of the two members. Also, guide member 86 includes a roller 90 that serves as an anti-friction member that reduces wear between guide member 86 and the rear edge of truck 14.

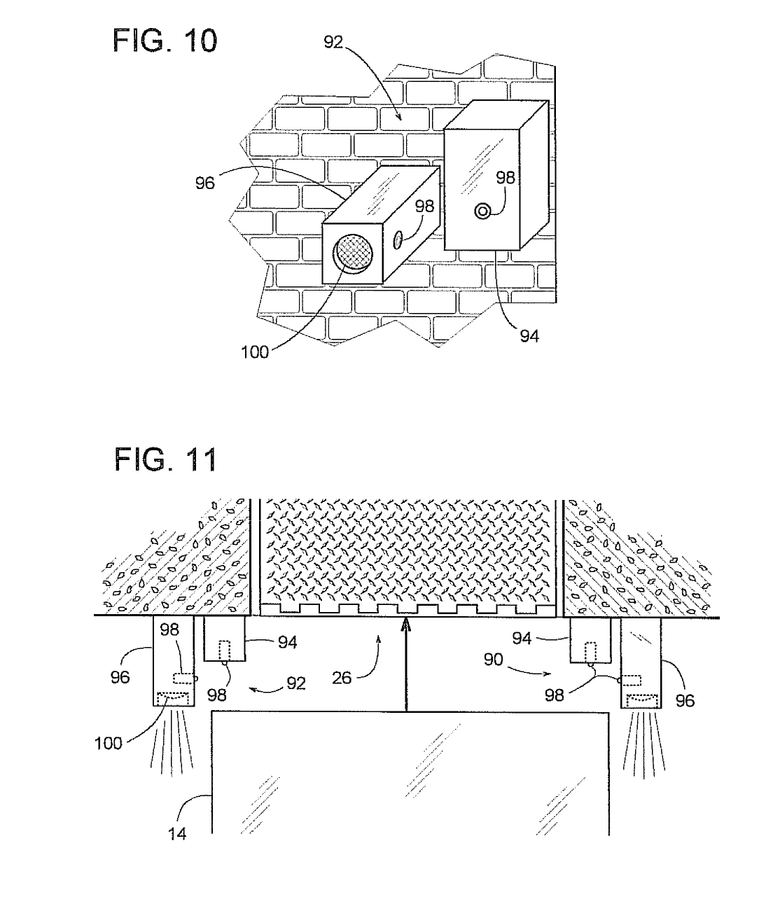

In yet another embodiment, shown in FIGS. 10 and 11, bumpers 90 and 92 include an engagement member 94, a guide member 96, and a sensor 98 responsive to the position of vehicle 14. Sensor 98 can be used to determine whether vehicle 14 is in the correct position relative to the loading dock. In response to sensing the position of vehicle 14, sensor 98 can be used to control a light 100 for providing the truck driver or dockworkers with a visual signal of the vehicle's position. Sensor 98 can also be used as part of an overall bumper system wherein sensor 98 selectively enables and disables the operation of dock leveler 26, an inflatable dock seal, vehicle restraint 28, and/or a powered door associated with doorway 18. Sensor 98 can be disposed within guide member 96, disposed within engagement member 94, or separately mounted adjacent bumpers 90 and 92. One or more sensors can be used for any given bumper system. Sensor 98 is schematically illustrated to represent a wide variety of sensors including, but not limited to, a conventional electromechanical limit switch, proximity switch, photoelectric eye, pressure switch, etc.

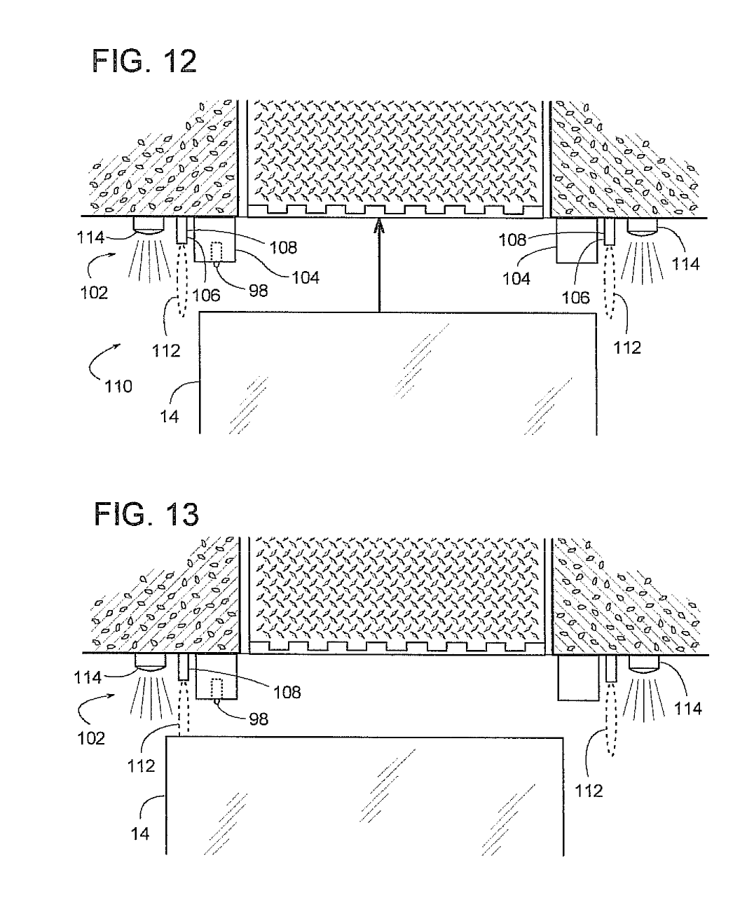

In the embodiment of FIGS. 12 and 13, a bumper system 102 includes an engagement member 104 and a guide member 106, wherein guide member 106 comprises a photoelectric eye 108. Photoelectric eye 108 allows guide member 106 to help in guiding vehicle 14 into a loading dock 110 without guide member 106 ever actually having to physically come in contact with vehicle 14. As vehicle 14 backs into the dock, a visible or invisible light beam 112 projecting from photoelectric eye 108 may be reflected or otherwise interrupted by the presence of vehicle 14, as indicated by the left side beam 112 of FIG. 13. If vehicle is off to one side and within a predetermined distance (per the specifications of the particular electric eye) in front of a photoelectric eye 108, then that photoelectric eye 108 could control a light 114 to turn on as a signal that vehicle 14 is misaligned relative to dock 1 10. However, if vehicle 14 is generally centered between guide members 106, as shown in FIG. 12, then beams 112 would be undisturbed and lights 114 would be individually energized or de-energized accordingly.

Although the invention is described with reference to a preferred embodiment, it should be appreciated by those skilled in the art that various modifications are well within the scope of the invention. Therefore, the scope of the invention is to be determined by reference to the claims that follow.

We claim:

1. A bumper for engaging at least one of a rear surface and a side surface of a vehicle that is adjacent a dock face of a loading dock, wherein the bumper includes a sensor responsive to the position of the vehicle relative to the bumper.

2. The bumper of claim 1, wherein the sensor is responsive to the distance between the bumper and the vehicle measured outward from the dockface.

3. The bumper of claim 1, wherein the loading dock includes an imaginary centerline extending outwardly from the dock face, and the sensor is responsive to the lateral position of the vehicle relative to the centerline.

4. The bumper of claim 1, in combination with a light responsive to the sensor.

5. The bumper of claim 1, in combination with a visual signal indicative of the vehicle's position, wherein the visual signal is responsive to the sensor.

6. The bumper of claim 1, in combination with other loading dock equipment, wherein operation of the loading dock equipment is responsive to the sensor for enabling operation of the loading dock equipment.

7. The combination of claim 6, wherein the loading dock equipment is only enabled when the sensor determines the vehicle is in a correct operating position relative to the loading dock.

8. A method for operating a loading dock installation including a dock face, the steps comprising:
providing a loading dock with a bumper, a sensor that senses the position of the vehicle relative to the bumper, and a visual indicator;
as the vehicle approaches the loading dock installation, sensing the position of the vehicle relative to the bumper;
in response to the sensing of the vehicle's position, actuating the visual indicator to provide a signal indicative of vehicle position.

9. The method of claim 8, wherein the signal is indicative of the distance of the vehicle from the bumper measured outward from the dock face.

10. The method of claim 8, wherein the signal is indicative of the distance of the vehicle laterally relative to an imaginary centerline extending outward from the dock face.
